(19) United States
(12) Patent Application Publication
(10) Pub. No.: US 2022/0361393 A1
(43) Pub. Date: Nov. 17, 2022

(54) Winged Agricultural Implement with Steerable Transport Wheels

(71) Applicant: ELMER'S WELDING & MANUFACTURING LTD., Altona (CA)

(72) Inventors: Michael I. J. Friesen, Altona (CA); Rheal M. Boileau, Altona (CA)

(21) Appl. No.: 17/724,842

(22) Filed: Apr. 20, 2022

Related U.S. Application Data
(60) Provisional application No. 63/189,473, filed on May 17, 2021.

(51) Int. Cl. A01B 73/06; A01B 63/24; A01B 63/32

(52) U.S. Cl. CPC A01B 73/067; A01B 63/245; A01B 63/32

(57) ABSTRACT

A towable agricultural implement, having a center frame and two wing frames pivotally coupled on the center frame to move between a field frame position extending laterally outward and a range of transport positions extending generally rearward, further includes a transport wheel on each wing frame that is pivotal about an upright steering axis through a range of wheel positions including a neutral transport wheel position for rolling forwardly. Each transport wheel is pivotal from the neutral transport wheel position in either one of two opposing steering directions under control of a steering actuator through an overall range of greater than 90 degrees. The wheels can be steered in a common direction during transport. A control system can also attempt to maintain a constant angle between the center section and the wings to allow reversing while in transport mode.

This application claims the benefit under 35 U.S.C. 119(e) of U.S. provisional application Ser. No. 63/189,473, filed May 17, 2021.

### FIELD OF THE INVENTION

The present invention relates to an agricultural implement of the type having a center frame section and wing frame sections that are pivotal between a laterally oriented field position and a rearwardly trailing transport position with steerable transport wheels on the wing frame sections.

### BACKGROUND

With the increase in scale of farming operations, equipment has also increased in size. For rearward folding winged implements, this means an increase in length during transport mode which leads to more difficulty in completing turns. Winged implements also pose an issue when reversing, as the hinged pivot point allows the wings to travel in undesired directions.

Winged implements generally consist of three main frame pieces, a center section and two wing sections. The center section is supported by a set of tires while each wing is supported by a tire at one end and a hinge to the center section at the other end. The winged implement has two positions, a field mode, and a transport mode. During transport mode the wings long axis is parallel to the direction of travel, while in field mode the long axis is perpendicular to direction of travel. In the past, each mode necessitated an additional tire on the wing to correctly orient the tire for that mode.

Many new winged implements include a pivoting tire that can be used in both field and transport mode. Pivoting the tires may be functioned either on its own or synchronized with other functions of the implement. Pivoting wheels currently on the market turn the tires through a fixed range of 90 degrees in opposite directions from the field position to the transport position, which allows the tires to be used in both transport and field modes. The wheels cannot be rotated beyond the transport position in a direction opposite to the field position.

During transport, the length of the implement increases the difficulty of turns and increases the required space to successfully complete a turn without the implement travelling through the ditch. In addition to the difficulty of turning, reversing winged implements is difficult because of the forward hinge mount of the wing. The hinge mount allows the wing to move off the direction of travel. Reversing a winged implement generally requires assistance from additional vehicles such as forklifts.

### SUMMARY OF THE INVENTION

According to one aspect of the invention there is provided an agricultural implement for use with a towing vehicle arranged for towing the implement frame across ground in a forward working direction of the towing vehicle, the implement comprising:

a center frame including a hitch member arranged for towing connection to the towing vehicle for movement across the ground in the forward working direction;

two wing frames, each wing frame being elongate along a longitudinal axis of the wing frame between an inner end and an outer end of the wing frame;

the wing frames being pivotally coupled at the inner ends of the wing frames at laterally spaced apart positions on the center frame;

each wing frame being pivotal relative to the center frame between a field frame position in which the longitudinal axes of the wing frames extend laterally outwardly in opposing directions from the center frame and a range of transport positions in which the longitudinal axes of the wing frames extend generally rearward from the center frame, the range of transport frame positions including a neutral transport frame position in which the longitudinal axis of the wing frame is oriented in the forward working direction of the center frame;

a transport wheel supported on each wing frame so as to be arranged to support the wing frame for rolling movement along the ground in at least the range of transport frame positions;

each transport wheel being pivotal relative to the wing frame about an upright steering axis through a range of wheel positions including a neutral transport wheel position in which an axis of the wheel is oriented perpendicularly to the longitudinal axis of the wing frame for rolling movement in the forward working direction when the wing frames are in the neutral transport frame positions;

each transport wheel being pivotal about the upright steering axis from the neutral transport wheel position in either one of two opposing steering directions;

and a steering actuator associated with each transport wheel in which the steering actuator is arranged to controllably steer the transport wheel in both opposing steering directions from the neutral transport wheel position.

The transport wheels can be steered in the same direction for steering while remaining in the transport position, in addition to steering in opposite directions to allow pivoting into the field position. In addition to the two previously mentioned features, a control system with a method of detecting the angle of the tires with respect to the wings and the wings with respect the center section can be added. The control system would allow the winged implement to reverse while in transport mode, automatically steer while driving forward in transport mode and ease the reversing portion of the transition between field and transport mode. To reverse, the system would typically try to maintain a constant angle between the center section and the wings. In addition to allowing reversing while in transport mode, the steerable transport wheels can ease the transition between field and transport modes by automatically adjusting the tire to wing angle to minimize implement travel distance required.

The steerable transport wheel described herein may embody the following features: (i) Can rotate the wheel in the same direction and opposite directions; (ii) Has a larger rotational range then the standard 90 degrees; (iii) Can be actuated hydraulic, electronically, or mechanically; (iv) Wheels can be “steered” in which both wheels turn in a similar direction of rotation, not necessarily parallel, with one manual circuit or an automatic circuit; (v) May be activated by the operator or by an automated control system; (vi) Can use input from sensors to determine the optimal angle of the steering system for the desired task; (vii) Can have a mechanical feedback/steering loop; (viii) Can assist in reversing a winged implement in transport mode; (ix) Can automatically even left and right wings during the transition from transport to field mode; and (x) Can automatically assist while cornering.

The wheel positions of each transport wheel preferably include a field wheel position in which the axis of the wheel is oriented parallel to the longitudinal axis of the wing frame so as to be arranged to support the wing frame for rolling movement along the ground in the forward working direction when the wing frames are in the field frame positions.

Preferably each transport wheel is pivotal about the upright steering axis through a range of more than 90 degrees.

A locking member may be arranged to fix an orientation of each transport wheel immovably in the field wheel position and/or in the neutral transport wheel position.

Preferably the steering actuators of the transport wheels of the two wing frames are actuatable so as to steer the transport wheels in a common direction of rotation from the respective neutral transport wheel positions of the transport wheels.

The implement may be further provided with (i) a controller operatively connected to each steering actuator and (ii) an input device operatively associated with each wing frame so as to be arranged to provide an input to the controller representative of a deflection angle of the wing frame away from the neutral transport frame position, in which the controller is operable to actuate the steering actuators in response to the input from the input devices.

The controller may be operable in a forward automated mode in which the controller is arranged to actuate the steering actuators of the transport wheels in a direction corresponding to steering of the wing frames towards the neutral transport frame positions when the central frame is displaced across the ground in the forward working direction.

The controller may also be operable in a reverse automated mode in which the controller is arranged to actuate the steering actuators of the transport wheels in a direction corresponding to steering of the wing frames towards the neutral transport frame positions when the central frame is displaced rearwardly across the ground opposite to the forward working direction.

Preferably the controller is arranged to actuate the steering actuators of both transport wheels by a variable amount that is proportional to the deflection angle.

The input device of each wing frame may be arranged to measure an angle of the wing frame relative to the center frame.

When the implement further includes a bracing arrangement associated with each wing frame in which each bracing arrangement is operatively connected to the wing frame and the center frame so as to define a four-bar linkage, the input device of each wing frame may be arranged to measure an angle between any adjacent pair of links of the four-bar linkage.

When the input device is an electronic sensor, the controller may be a programmable controller arranged to receive input from the electronic sensor as an electronic signal and actuate the steering actuators in response to the electronic signal from the sensors.

When the steering actuators comprise hydraulic actuators, the input devices may be hydraulic devices. In this instance, the controller may be arranged to receive input from the hydraulic device as a flow of hydraulic fluid, and actuate the steering actuators in response to the flow of hydraulic fluid from the input devices.

Alternatively, the controller may comprise a control linkage connected between each transport wheel and the corresponding wing frame, in which the input device comprises an input linkage operatively connected between the central frame and the control linkage.

The steering actuators may be arranged for connection to a controllable output of the towing vehicle such that the steering actuators can be manually operated by an operator of the towing vehicle using controls of the towing vehicle.

### BRIEF DESCRIPTION OF THE DRAWINGS

One embodiment of the invention will now be described in conjunction with the accompanying drawings in which:

FIG. 1 is a schematic view of the agricultural implement in the field position of the wing frames;

FIG. 2 is a schematic view of the agricultural implement in the neutral transport position of the wing frames according to the implement of FIG. 1;

FIG. 3 is a perspective view of the transport wheel of one wing frame shown in the field position of the wheel according to the implement of FIG. 1;

FIG. 4 is a top plan view of the transport wheel of FIG. 3 in the neutral transport position of the wheel;

FIGS. 5 and 6 are top plan the use of the transport wheel of FIG. 3 in which the wheel has been steered in opposing directions from the neutral transport position of the wheel;

FIG. 7 is a schematic representation of a controller arrangement according to one embodiment of the agricultural implement;

FIG. 8A is a schematic representation of the implement navigating a turn with the transport wheels locked in the neutral transport position of the wheels;

FIG. 8B is a schematic representation of the implement navigating a turn with the transport wheels of the two wing frames steered in a common direction of rotation away from the neutral transport position of the wheels, for example under manual control by an operator of the towing vehicle;

FIGS. 9A through 9D are schematic representations illustrating a sequence of the implement navigating a turn in a forward automated mode in which the transport wheels are automatically steered in a common direction of rotation from the neutral transport positions of the wheels proportionally to angular deflection of the respective wing frames being deflected from the neutral transport positions of the wing frames to return the wing frames towards the neutral transport positions thereof as the implement is displaced forwardly; and

FIGS. 10A through 10D are schematic representations illustrating a sequence of the implement navigating a turn in a reverse automated mode in which the transport wheels are automatically steered in a common direction of rotation from the neutral transport positions of the wheels proportionally to angular deflection of the respective wing frames being deflected from the neutral transport positions of the wing frames to return the wing frames towards the neutral transport positions thereof as the implement is displaced rearwardly.

In the drawings like characters of reference indicate corresponding parts in the different figures.

### DETAILED DESCRIPTION

Referring to the accompanying figures there is illustrated an agricultural implement generally indicated by reference numeral 10. The implement is intended to be operated with a towing vehicle 12, for example an agricultural tractor arranged to displace the implement in a forward working direction of the tractor across ground. The implement supports ground working tools 14 thereon, for example discs, harrow tines, furrow openers, rollers and the like, for working the ground as the implement is displaced across the ground.

The agricultural implement includes a center frame 16 having a center toolbar section thereon that supports some of the ground working tools. The center frame 16 includes a hitch arm 18 projecting forwardly therefrom for towing connection to the towing vehicle 12. Two support wheels 20 are carried on the center frame 16 at laterally spaced apart positions thereon to support the center frame for rolling movement along the ground in the forward working direction. The support wheels 20 are fixed in orientation relative to the center frame.

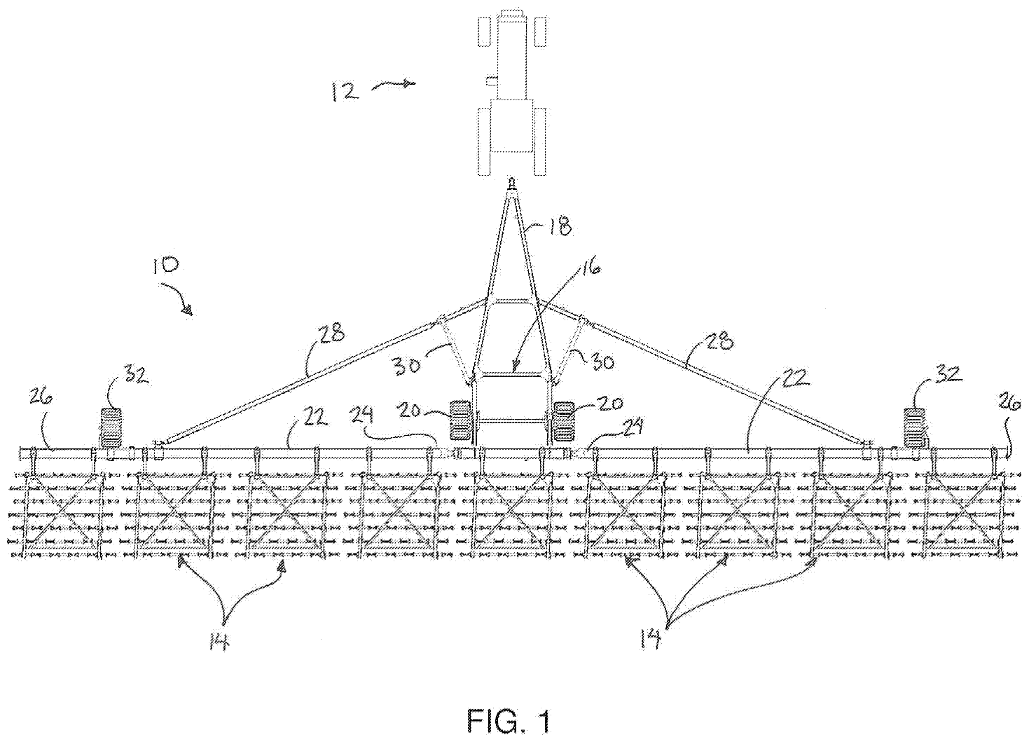

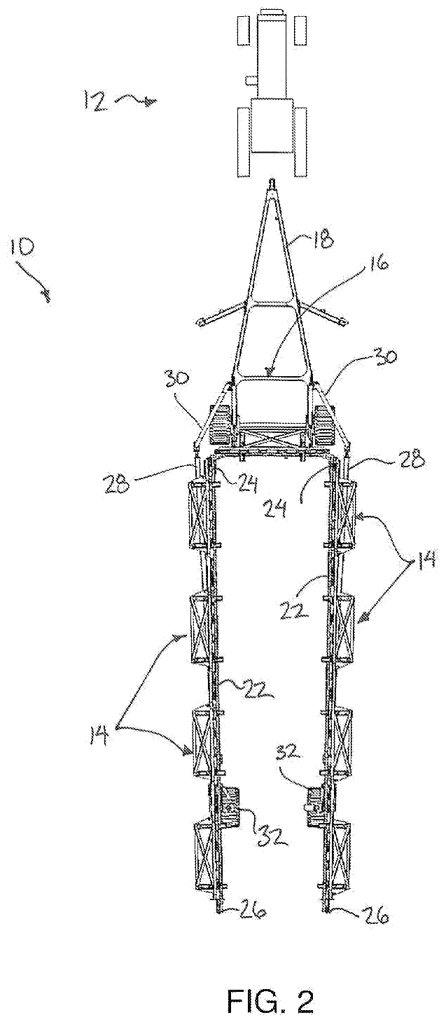

The implement further includes two wing frames 22. Each wing frame is elongate in the direction of a respective longitudinal axis of the wing frame that extends between an inner end 24 and an outer end 26 of the respective wing frame. Each wing frame further supports a respective toolbar section thereon for supporting additional ones of the ground working tools 14 thereon. The two wing frames 22 are pivotally coupled at laterally opposing sides of the center frame 16 at the inner ends 24 of the wing frames respectively. In this manner the wing frames 22 are pivotal relative to the center frame 16 between a field position of the wing frames as shown in FIG. 1 and one or more transport positions of the wing frames represented in FIG. 2.

In the field position of the wing frames, the longitudinal axes of the wing frames are oriented perpendicularly to the forward working direction such that the wing frames extend laterally outwardly in opposing directions from the opposing sides of the center frame 16. A bracing arrangement can be used to support the wing frames in fixed relation to the center frame in the field position.

In the illustrated embodiment, the bracing arrangement for each wing frame includes a brace arm 28 that is pivotally coupled at an outer end at an intermediate location between the inner and outer ends of the wing frame. The brace arm of each wing frame is also releasably coupled at an inner end onto a fixed receiver on the center frame 16. The bracing arrangement further includes an additional guide arm 30 that is pivotally coupled at the inner end of the brace arm 28 at one end while being pivotally coupled on the center frame at the opposing end at a location spaced from the pivotal connection of the wing frame to the center frame. In this manner the bracing arrangement defines a four-bar linkage comprised of a set of four links that includes a portion of the wing frame, a portion of the center frame, the brace arm 28, and the guide arm 30. The linkage serves to fold the brace arm 28 alongside the wing frame as the wing frame is folded rearwardly from the field position towards the transport position thereof.

The one or more transport positions of the wing frames include a neutral transport position of the wing frames in which the longitudinal axes of the wing frames extend rearwardly from the center frame so as to be parallel to the forward working direction as shown in FIG. 2. The wing frames typically remain freely pivotal about the upright pivot axes of the wing frames relative to the center frame to allow angular deflection of the wing frames in either left or right lateral directions away from the neutral transport position of the wing frames, thus defining an overall range of transport positions of the wing frames during transport.

The implement 10 further includes a steerable transport wheel 32 supported on each wing frame at a location which is nearer to the outer end than the inner end but which remains spaced inwardly from the outer end according to the illustrated embodiment. The steerable wheels support the wing frames for rolling movement along the ground at least in the transport position.

Although the steerable wheels 32 are usable to support the wing frames in both the transport position and the field position in the illustrated embodiment, in alternative embodiments rolling support for the wing frames across the ground in the field position may be provided by separate field wheels while still enjoying some of the benefits of the present invention when the steerable wheels 32 remain steerable for use only in the transport position.

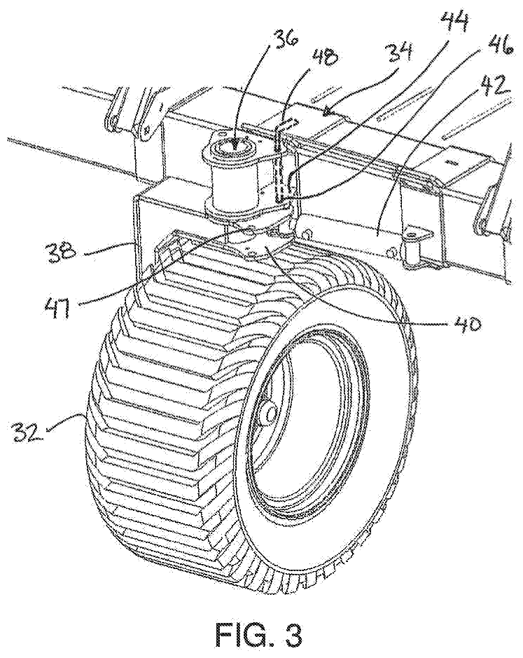

In the illustrated embodiment, each steerable transport wheel 32 is pivotal through a range of greater than 90 degrees, and preferably greater than 120 degrees, through a range of positions including a field position of the wheel as shown in FIGS. 1 and 3 and a range of transport positions of the wheels as shown in FIGS. 2, 4, 5 and 6.

In the field position of each steerable wheel 32, the rolling direction of the wheel is oriented perpendicularly to the longitudinal axis of the wing frame so as to be arranged for rolling movement in the forward working direction of the center frame when the wing frames are supported in the fields positions thereof. The steerable wheels can be locked in the field positions of the wheels through various means as described below.

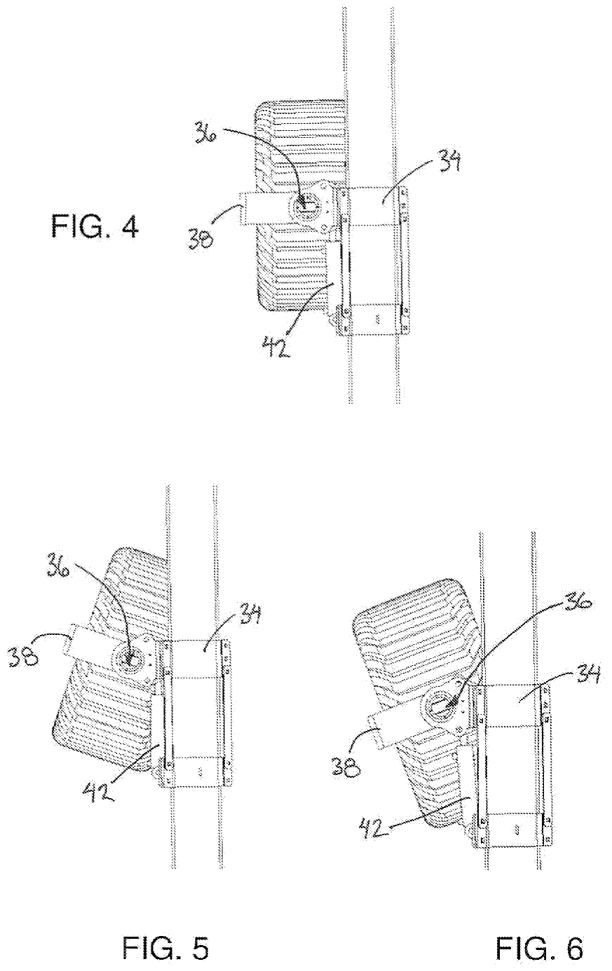

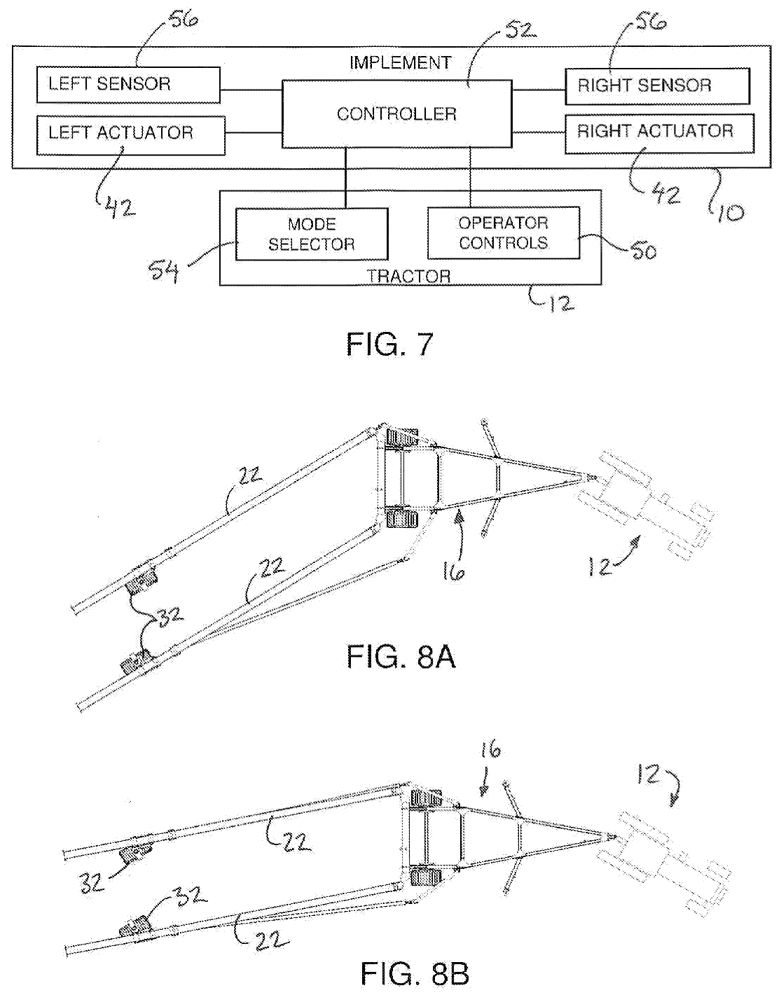

The transport positions of the steerable wheels 32 include a neutral transport position according to FIG. 4 in which the rolling direction of the wheel is oriented parallel to the longitudinal axis of the wing frame and parallel to the forward working direction when the wing frame is in the neutral transport position thereof. The steerable wheels can be locked in the neutral transport positions of the wheels through various means as described further below.

When in the neutral transport position, for forward cornering of the implement, each steerable wheel 32 remains pivotal in either one of two opposing directions of rotation from the neutral orientation for steering in opposing left or right lateral directions as may be desired. For example, each steerable wheel 32 may be pivotal through a range of approximately 60 degrees in either direction of rotation from the neutral transport position of the steerable wheel when in the transport configuration of the implement.

In the illustrated embodiment, each steerable wheel 32 is carried on a portion of the respective wing frame by a suitable mounting bracket 34 that supports a vertical pivot shaft 36 rotatably thereon such that the pivot shaft defines a vertical steering axis of the steerable wheel relative to the wing frame. A wheel frame 38 is carried on the bottom end of the pivot shaft for rotation about the upright steering axis relative to the wing frame. The wheel frame 38 rotatably supports the steerable wheel 32 thereon for rotation about a respective wheel axis of the wheel to define the rolling orientation of the wheel in perpendicular relation to the wheel axis.

A positioning member 40 is mounted at the bottom end of the pivot shaft 36 so as to be fixed immovably relative to the wheel frame 38 for pivoting movement together about the vertical steering axis. The positioning member 40 comprises a plate member oriented perpendicularly to the steering axis to protrude radially outward from the pivot shaft to function as a crank arm that connects to a steering actuator 42 associated with the steerable wheel 32. The steering actuator 42 in the illustrated embodiment is a hydraulic linear actuator mounted between the wing frame and the positioning member 40 such that extending and retracting the overall length of the actuator 42 acts to controllably pivot and steer the wheel carried on the wheel frame 38 relative to the wing frame. The overall range of the steering actuator 42 encompasses the range of movement of the steerable wheel from the field position to the range of transport positions.

A stop plate 44 is mounted on the bracket 34 so as to be fixed immovably relative to the wing frame while being located in proximity to the pivot shaft 36 and the positioning member 40 thereon. The stop plate 44 defines one or more locking apertures 46 therein for alignment with one or more corresponding locking apertures 47 on the positioning member 40. One of the locking apertures 46 on the stop plate 44 aligns with one of the locking apertures 47 on the positioning member 40 in each of the field position and the neutral transport position of the steerable wheel 32 so that a locking pin 48 can be inserted through the aligned apertures and thereby lock the steerable wheel in the corresponding position. The locking pin is mounted to be longitudinally slidable along an axis of the pin relative to the positioning member for insertion into or removal from any one of the cooperating apertures to lock or release pivotal movement of the steerable wheel relative to the wing frame as selected by an operator. In this manner, the rolling orientation of the steerable wheel 32 can be fixed immovably relative to the wing frame by insertion of the locking pin into a corresponding aligned pair of apertures 46 and 47 in either of the field position or the neutral transport position of the wheel. The locking pin 48 can function as the primary means of fixing the wheels in a selected orientation or may function in a redundant manner to the steering actuator 42 which can instead be used to lock the wheel in a selected orientation. The steering actuator 42 can also be used as the sole means of locking the steerable wheel 32 in the field position or the neutral transport position of the wheel if desired.

The steering actuators 42 for the left wing frame and the right wing frame respectively can be operated in a manner that allows the steerable wheels 32 for the left wing frame and the right wing frame to be steered together in a common direction of rotation from their respective neutral transport positions for steering the wing frames together relative to the center frame in the transport configuration of the implement. Preferably the control of the steering actuators 42 also allows for the actuators to be controlled in a manner that results in the wheels being controllably pivoted in opposite directions of rotation from the transport positions to the field positions thereof when desired.

In the illustrated embodiment, when the steering actuators 42 comprise hydraulic linear actuators, the actuators are coupled to a controllable output of the towing vehicle 12. A first valving arrangement may hydraulically link the actuators such that the actuators steer the steerable wheels 32 in a common direction of rotation for steering the wing frames in the transport positions under a common operator input through operator controls 50 of the towing vehicle. Alternatively, a second valving arrangement may hydraulically link the actuators such that the actuators steer the steerable wheels 32 in opposing directions of rotation for steering the wing frames into the field position under a common operator input through the operator controls 50 of the towing vehicle. The first and second valve arrangements in this instance may collectively form part of an overall controller 52 of the steering system of the implement. The controller 52 may respond to input from an operator of the towing vehicle through a mode selector 54 of the steering system which can select between use of the first or second valving arrangements described above.

In addition to an arrangement of valves for controllably directing hydraulic flow to the actuators 42 to steer the wheels 32 in the desired manner, the controller 52 of the steering system of the implement may further comprise a programmable controller including a processor and a memory storing program instructions executable by the processor to perform various automated functions to automatically control of the valving arrangements that actuate the steering actuators 42 in response to different operator instructions received through the operator controls 50 or through the mode selector 54.

The steering system of the implement preferably includes an input device 56 associated with each wing frame to generate an input for the steering system which is indicative of an angular position of the wing frame relative to the center frame among the range of transport positions. In particular, the input device may generate an input signal for the controller 52 which is representative of a deflection angle of the wing frame away from the neutral transport position of the wing frame so that the steering actuators can be appropriately actuated to proportionally steer the steerable wheels 32 away from the neutral transport position of the wheels in a manner that acts to return the wing frames towards their neutral transport positions as the implement is displaced forwardly or rearwardly across the ground depending upon the selected mode.

When the controller 52 is a programmable controller, various automated modes of operation can be executed by the steering system of the implement using input devices 56 in the form of electronic sensors capable of measuring an angle of the associated wing frame relative to the center frame such that the controller can determine the amount of deflection of each wing frame from the neutral transport frame position when towing the implement in the transport configuration.

In one embodiment, each angular sensor 56 is connected between the respective wing frame in the center frame for directly measuring angular deflection of the wing frame.

In an alternative embodiment, each angular sensor 56 may be connected between any adjacent pair of links in the four-bar linkage defined by the bracing arrangement of the respective wing in which the linkage includes a portion of the center frame, a portion of the wing frame, the brace arm 28 and the guide arm 30. In this instance, the angular position of the wing frame relative to the center frame can be calculated from the measured angle and the known relationship between the links of the four-bar linkage.

In a further arrangement, automated steering can still be achieved by use of a controller that is defined by a mechanical control linkage operatively connected between each steerable wheel 32 and the wing frame. The input device 56 in this instance may comprise an input linkage connected between the control linkage and the central frame of the implement such that pivoting movement of the wing frame relative to the center frame automatically results in controlled steering of the steerable wheel in a direction that acts to return the wing frame towards the neutral transport position thereof.

In yet a further arrangement, automated steering can also be achieved by use of a controller represented by a hydraulic circuit that communicates hydraulic fluid to the hydraulic steering actuators 42 from input devices in the form of hydraulic devices operatively connected between the wing frame in the center frame. In this manner, the input devices respond to pivotal movement of the wing frames relative to the central frame away from the neutral transport position of the frames so as to redirect hydraulic fluid to the steering actuators 42 in an automated manner that again results in controlled steering of the steerable wheels in a direction that acts to return the wing frames towards their respective neutral transport positions.

When the controller 52 is a programmable controller that can be operated in a variety of modes as selected by the operator through a mode selector 54, the various modes can include (i) a locked field mode in which the hydraulic actuators of the steerable wheels are locked in the field positions thereof, (ii) a locked transport mode in which the hydraulic actuators of the steerable wheels are locked in the transport positions thereof, (iii) a forward automated mode in which the steerable wheels are automatically steered in the same direction by the controller to function to return the wing frames towards the neutral transport positions thereof when the implement is displaced in the forward working direction, (iv) a rearward automated mode in which the steerable wheels are automatically steered in the same direction by the controller to function to return the wing frames towards the neutral transport positions thereof when the implement is displaced rearwardly, and (v) a field deployment mode in which the steerable wheels are automatically steered in opposite directions by the controller to steer both wing frames towards the field positions thereof when the implement is displaced rearwardly.

In both the forward and rearward automated modes, the controller 52 monitors the input signal from the input devices 56 to determine if the wing frames remain in the neutral transport position relative to the central frame, and if not, determine the amount of deflection of the wing frames away from the neutral transport position. If the wing frames remain in the neutral transport position, then the actuators are operated to maintain the wheels in the neutral transport positions thereof relative to the wing frames. If an amount of deflection of either wing frame from the neutral transport position thereof is determined, then appropriate control signals are sent to the actuator associated with that wing frame to steer the corresponding steerable wheel to return the wing frame toward the neutral transport position. The controller is arranged to steer each wheel away from the neutral transport position of that wheel by an amount that is proportional to the deflection of the corresponding wing frame away from the neutral transport position of that wing frame. As the amount of deflection of the wing frame decreases, so does the controlled steering angle of the corresponding wheel from the respective neutral transport position of the wheel.

In practice, both wing frames typically follow a similar path when following the towing vehicle such that a single angular input representative of the angular deflection of both wing frames could be used to controllably steer both steerable wheels in a similar manner; however, due to the difference in radius between one wing frame following the inside of a curved path and the other wing frame following the outside of a curved path it is preferred that each of the steerable wheels is controlled independently in response to a measured angle associated with that wing frame.

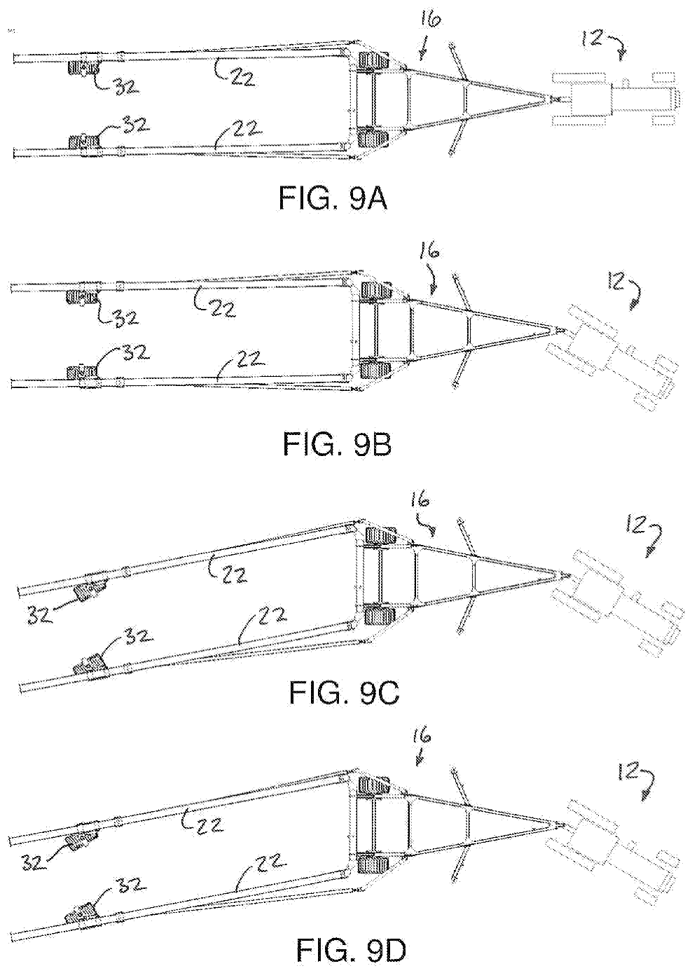

FIGS. 9A through 9D illustrate a typical sequence of events of the implement navigating a turn in the forward mode of operation. Initially the steerable wheels remain in the neutral transport positions thereof relative to the wing frames and remain so while the towing vehicle initiates a turn provided that the wing frames remain in the neutral transport positions of the wing frames relative to the central frame as shown in FIGS. 9A and 9B. Once a deflection of the wing frames from the neutral transport position is detected in a first lateral direction, for example to the right as shown in FIG. 9C, the steering actuators are actuated by the controller to steer each steerable wheel so that the front of the wheel is offset in an opposing second lateral direction, for example to the left as shown in FIG. 9C, thus acting to steer the wing frames back towards the neutral transport positions of the wing frames when the central frame is continued to be displaced across the ground in the forward working direction. Even as the central frame straightens out relative to the towing vehicle as shown in FIG. 9D, the steerable wheels are continued to be steered in the second lateral direction until the wing frames return to the neutral transport position of the wing frames. Likewise, when the controller detects that the wing frames are deflected from their neutral transport positions in a second lateral direction, the steering actuators are actuated by the controller to steer each steerable wheel in the opposing first lateral direction to steer the wing frames back towards the neutral transport positions of the wing frames when the central frame is continued to be displaced across the ground and the forward working direction.

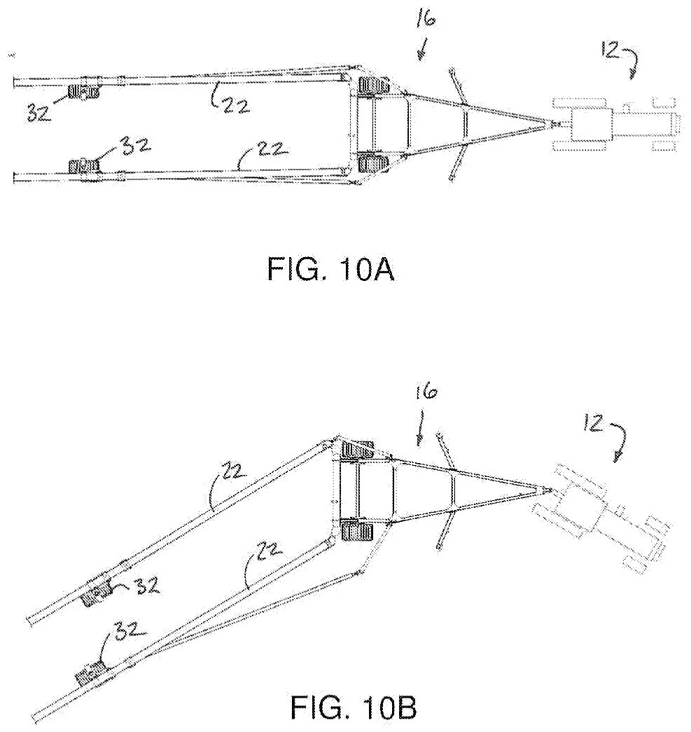

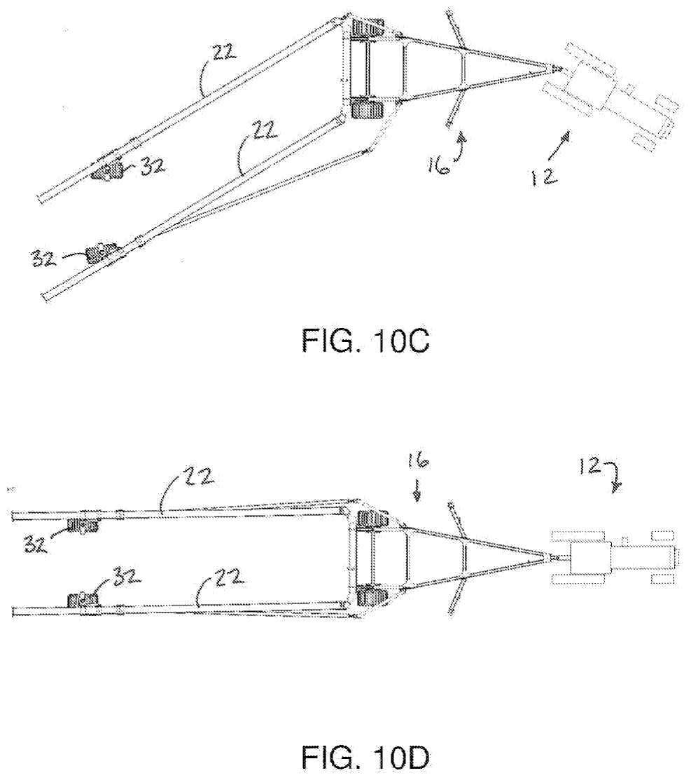

FIGS. 10A through 10D illustrate a typical sequence of events of the implement navigating a turn in the reverse mode of operation. Initially the steerable wheels remain in the neutral transport positions thereof relative to the wing frames and remain so while the towing vehicle initiates reversing. If the wing frames begin to be angularly deflected away from the neutral transport positions thereof while reversing as shown in FIG. 10B, the deflection angle of the wing frames is detected and the wheels are controllably steered under direction of the controller. In the reverse mode, when a deflection of the wing frames from the neutral transport position is detected in a first lateral direction, for example to the right as shown in FIG. 10B, the steering actuators are actuated by the controller to steer each steerable wheel so that the front of the wheel is offset in the same first lateral direction thus acting to steer the wing frames back to the neutral transport positions of the wing frames when the central frame is continued to be displaced rearwardly across the ground as shown in FIG. 10C. As the deflection angle of the wing frames decreases, the steering angle of the wheels also decreases such that the wheels and the wing frames each eventually assume the neutral transport positions thereof as the implement continues to be displaced rearwardly by the towing vehicle according to FIG. 10D. Likewise, when the controller detects that the wing frames are deflected from their neutral transport positions in a second lateral direction, the steering actuators are actuated by the controller to steer each steerable wheel so that the front end of the wheel is offset in the same second lateral direction to again steer the wing frames back towards the neutral transport positions of the wing frames when the central frame is continued to be displaced rearwardly across the ground.

In the field deployment mode, the controller may function to actuate the steerable wheels of the two wing frames to be pivoted in opposite directions of rotation relative to one another from the transport positions to the field positions of the wheels. This allows the operator to reverse the implement and deploy the wing frames from the transport positions to the field positions of the wing frames. The displacement of the wheels into the field positions of the wheels can be accomplished without feedback by controlling the wheels to be steered together. Alternatively, the controller may monitor input from the input devices 56 to gauge the angular deflection of the two wing frames relative to the central frame as the implement is reversed across the ground so that the wheels can be controllably steered through a range of angles from the transport position to the field position. In this instance, the controller steers the wheels independently of one another so as to unfold the wing frames from the transport positions to the field positions thereof in a balanced manner symmetrically with one another about an axis oriented in the forward working direction of the center frame.

Since various modifications can be made in my invention as herein above described, and many apparently widely different embodiments of same made, it is intended that all matter contained in the accompanying specification shall be interpreted as illustrative only and not in a limiting sense.

1. An agricultural implement for use with a towing vehicle arranged for towing the implement frame across ground in a forward working direction of the towing vehicle, the implement comprising:
a center frame including a hitch member arranged for towing connection to the towing vehicle for movement across the ground in the forward working direction;
two wing frames, each wing frame being elongate along a longitudinal axis of the wing frame between an inner end and an outer end of the wing frame;
the wing frames being pivotally coupled at the inner ends of the wing frames at laterally spaced apart positions on the center frame;
each wing frame being pivotal relative to the center frame between a field frame position in which the longitudinal axes of the wing frames extend laterally outwardly in opposing directions from the center frame and a range of transport positions in which the longitudinal axes of the wing frames extend generally rearward from the center frame, the range of transport frame positions including a neutral transport frame position in which the longitudinal axis of the wing frame is oriented in the forward working direction of the center frame;
a transport wheel supported on each wing frame so as to be arranged to support the wing frame for rolling movement along the ground in at least the range of transport frame positions;
each transport wheel being pivotal relative to the wing frame about an upright steering axis through a range of wheel positions including a neutral transport wheel position in which an axis of the wheel is oriented perpendicularly to the longitudinal axis of the wing frame for rolling movement in the forward working direction when the wing frames are in the neutral transport frame positions;
each transport wheel being pivotal about the upright steering axis from the neutral transport wheel position in either one of two opposing steering directions;
and a steering actuator associated with each transport wheel in which the steering actuator is arranged to controllably steer the transport wheel in both opposing steering directions from the neutral transport wheel position.

2. The implement according to claim 1 wherein the wheel positions of each transport wheel include a field wheel position in which the axis of the wheel is oriented parallel to the longitudinal axis of the wing frame so as to be arranged to support the wing frame for rolling movement along the ground in the forward working direction when the wing frames are in the field frame positions.

3. The implement according to claim 2 further comprising a locking member arranged to fix an orientation of each transport wheel immovably in the field wheel position.

4. The implement according to claim 1 further comprising a locking member arranged to fix an orientation of each transport wheel immovably in the neutral transport wheel position.

5. The implement according to claim 1 wherein the steering actuators of the transport wheels of the two wing frames are actuatable so as to steer the transport wheels in a common direction of rotation from the respective neutral transport wheel positions of the transport wheels.

6. The implement according to claim 1 further comprising a controller operatively connected to each steering actuator and an input device operatively associated with each wing frame so as to be arranged to provide an input to the controller representative of a deflection angle of the wing frame away from the neutral transport frame position, the controller being operable to actuate the steering actuators in response to the input from the input devices.

7. The implement according to claim 6 wherein the controller is operable in a forward automated mode in which the controller is arranged to actuate the steering actuators of the transport wheels in a direction corresponding to steering of the wing frames towards the neutral transport frame positions when the central frame is displaced across the ground in the forward working direction.

8. The implement according to claim 6 wherein the controller is operable in a reverse automated mode in which the controller is arranged to actuate the steering actuators of the transport wheels in a direction corresponding to steering of the wing frames towards the neutral transport frame positions when the central frame is displaced rearwardly across the ground opposite to the forward working direction.

9. The implement according to claim 6 wherein the controller is arranged to actuate the steering actuators of both transport wheels by a variable amount that is proportional to the deflection angle.

10. The implement according to claim 6 wherein the input device of each wing frame is arranged to measure an angle of the wing frame relative to the center frame.

11. The implement according to claim 6 further comprising a bracing arrangement associated with each wing frame, each bracing arrangement being operatively connected to the wing frame and the center frame so as to define a four-bar linkage, and wherein the input device of each wing frame is arranged to measure an angle between any adjacent pair of links of the four-bar linkage.

12. The implement according to claim 6 wherein the input device is an electronic sensor and wherein the controller is a programmable controller arranged to receive input from the electronic sensor as an electronic signal and actuate the steering actuators in response to the electronic signal from the sensors.

13. The implement according to claim 6 wherein the steering actuators comprise hydraulic actuators, wherein the input devices are hydraulic devices, and wherein the controller is arranged to receive input from the hydraulic device as a flow of hydraulic fluid, and actuate the steering actuators in response to the flow of hydraulic fluid from the input devices.

14. The implement according to claim 1 wherein the controller comprises a control linkage connected between each transport wheel and the corresponding wing frame and wherein the input device comprises an input linkage operatively connected between the central frame and the control linkage.

15. The implement according to claim 1 wherein the steering actuators are arranged for connection to a controllable output of the towing vehicle such that the steering actuators can be manually operated by an operator of the towing vehicle using controls of the towing vehicle.

16. The implement according to claim 1 wherein each transport wheel is pivotal about the upright steering axis through a range of more than 90 degrees.
